(19) United States
(12) Patent Application Publication
(10) Pub. No.: US 2020/0016827 A1
(43) Pub. Date: Jan. 16, 2020

(54) RESIN POWDER FOR PRODUCING THREE-DIMENSIONAL OBJECT, THREE-DIMENSIONAL OBJECT PRODUCING METHOD, AND THREE-DIMENSIONAL OBJECT PRODUCING APPARATUS

(71) Applicants: Yasuyuki YAMASHITA, Kanagawa (JP); Akira SAITO, Kanagawa (JP); Sohichiroh IIDA, Kanagawa (JP); Hitoshi IWATSUKI, Kanagawa (JP); Yasuo SUZUKI, Shizuoka (JP); Nozomu TAMOTO, Shizuoka (JP); Kiichi KAMODA, Kanagawa (JP); Shigenori YAGUCHI, Tokyo (JP); Shinzo HIGUCHI, Tokyo (JP); Toshiyuki ISEKI, Kanagawa (JP); Yasutomo AMAN, Kanagawa (JP); Toshiyuki MUTOH, Kanagawa (JP); Mitsuru NARUSE, Shizuoka (JP)

(72) Inventors: Yasuyuki YAMASHITA, Kanagawa (JP); Akira SAITO, Kanagawa (JP); Sohichiroh IIDA, Kanagawa (JP); Hitoshi IWATSUKI, Kanagawa (JP); Yasuo SUZUKI, Shizuoka (JP); Nozomu TAMOTO, Shizuoka (JP); Kiichi KAMODA, Kanagawa (JP); Shigenori YAGUCHI, Tokyo (JP); Shinzo HIGUCHI, Tokyo (JP); Toshiyuki ISEKI, Kanagawa (JP); Yasutomo AMAN, Kanagawa (JP); Toshiyuki MUTOH, Kanagawa (JP); Mitsuru NARUSE, Shizuoka (JP)

(21) Appl. No.: 16/495,327

(22) PCT Filed: Mar. 7, 2018
(86) PCT No.: PCT/JP2018/008779

§ 371 Date: Sep. 18, 2019

(30) Foreign Application Priority Data
Mar. 21, 2017 (JP) 2017-053873
Feb. 21, 2018 (JP) 2018-028721

(51) Int. Cl. B29C 64/153; B33Y 10/00; B33Y 30/00; B33Y 70/00; C08J 3/12

(52) U.S. Cl. CPC B29C 64/153; B33Y 10/00; B33Y 30/00; B33Y 70/00; C08J 2323/12; C08J 2367/02; C08J 2377/06; C08J 2371/00; C08J 2359/00; C08J 3/12

(57) ABSTRACT

Provided is a resin powder for producing a three-dimensional object, wherein the resin powder has a number-average equivalent circle diameter of 10 micrometers or greater but 150 micrometers or less, and wherein a median in an equivalent circle diameter-based particle size distribution of the resin powder is higher than the average equivalent circle diameter.

### TECHNICAL FIELD

The present disclosure relates to a resin powder for producing a three-dimensional object, a three-dimensional object producing method, and a three-dimensional object producing apparatus.

### BACKGROUND ART

A powder laminated object manufacturing method is a method of solidifying one layer of a powder-state material after another with a laser or a binder to manufacture an object.

The method using the laser is called a powder bed fusion (PBF) method. As the PBF method, a selective laser sintering (SLS) method of forming a three-dimensional object by selective laser irradiation, and a selective mask sintering (SMS) method of using a mask for planar laser irradiation are known. On the other hand, as the method using the binder, a binder jetting method of discharging an ink containing a binder resin by a method such as ink jetting to form a three-dimensional object is known.

Of these methods, the PBF method selectively irradiates a thin layer of a metal, a ceramic, or a resin with a laser beam to fuse the powder particles and make the powder particles adhere to each other to form a film, forms another layer on the formed film, and repeats the same operation, to sequentially laminate layers. In this way, the method can obtain a three-dimensional object (see, for example, PTLs 1 to 4).

In the case of using a resin powder in the PBF method, with an internal stress between thin layers kept low or relaxed, the layers of the resin powder supplied in a supplying tank are heated to a temperature close to the softening point of the resin, and selectively irradiated with a laser beam such that the irradiated resin powder particles are heated to a temperature higher than or equal to the softening point and fused with each other, to manufacture a three-dimensional object.

Currently, polyamide resins are often used in the PBF method. Particularly, polyamide 12 is suitable for use because polyamide 12 has a relatively low melting point among polyamides and has a low thermal shrinkage factor and a low water absorbency.

In recent years, there have been increasing needs for use of three-dimensional objects not only as prototypes but also as final products, giving rise to needs for use of various resins.

### CITATION LIST

### Patent Literature

### PTL 1: Japanese Unexamined Patent Application Publication No. 2015-180538

PTL 2: Japanese Translation of PCT International Application Publication No. JPT-2014-522331
PTL 3: Japanese Translation of PCT International Application Publication No. JPT-2013-529599
PTL 4: Japanese Translation of PCT International Application Publication No. JPT-2015-515434

### SUMMARY OF INVENTION

### Technical Problem

The present disclosure has an object to provide a resin powder for producing a three-dimensional object capable of providing a three-dimensional object to be obtained with an excellent density, an excellent dimensional stability, and an excellent surface property without degrading the strength, even if the resin powder has been stored in a high-humidity environment.

### Solution to Problem

According to one aspect of the present disclosure, a resin powder for producing a three-dimensional object has a number-average equivalent circle diameter of 10 micrometers or greater but 150 micrometers or less. A median in an equivalent circle diameter-based particle size distribution of the resin powder is higher than the average equivalent circle diameter.

### Advantageous Effects of Invention

The present disclosure provides a resin powder for producing a three-dimensional object capable of providing a three-dimensional object to be obtained with an excellent density, an excellent dimensional stability, and an excellent surface property without degrading the strength, even if the resin powder has been stored in a high-humidity environment.

### BRIEF DESCRIPTION OF DRAWINGS

FIG. 1 is an exemplary diagram illustrating an example of an approximately cylindrical body.

FIG. 2 is a schematic diagram illustrating an example of a three-dimensional object producing apparatus used in a three-dimensional object producing method of the present disclosure.

FIG. 3A is a schematic diagram illustrating an example of a step of forming a powder layer having a smooth surface.

FIG. 3B is a schematic diagram illustrating an example of a step of forming a powder layer having a smooth surface.

FIG. 3C is a schematic diagram illustrating an example of a step of dropping a liquid material for producing a three-dimensional object.

FIG. 3D is a schematic diagram illustrating an example of a step of newly forming a resin powder layer in a forming-side powder storing tank.

FIG. 3E is a schematic diagram illustrating an example of a step of newly forming a resin powder layer in a forming-side powder storing tank.

FIG. 3F is a schematic diagram illustrating an example of a step of dropping a liquid material for producing a three-dimensional object again.

FIG. 4 is a diagram illustrating a distribution of equivalent circle diameters of a resin powder for producing a three-dimensional object of Example 1.

FIG. 5 is a diagram illustrating a distribution of equivalent circle diameters of a resin powder for producing a three-dimensional object of Comparative Example 1.

FIG. 6 is a diagram illustrating a distribution of equivalent circle diameters of a resin powder for producing a three-dimensional object of Comparative Example 2.

### DESCRIPTION OF EMBODIMENTS

(Resin Powder for Producing Three-Dimensional Object)

A resin powder for producing a three-dimensional object of the present disclosure has a number-average equivalent circle diameter of 10 micrometers or greater but 150 micrometers or less. A median in an equivalent circle diameter-based particle size distribution of the resin powder is higher than the average equivalent circle diameter. The resin powder preferably contains a thermoplastic resin and further contains other components as needed.

The resin powder for producing a three-dimensional object of the present disclosure is based on a finding that existing resin powders for producing a three-dimensional object are affected by humidity in storage environments, to degrade the strength of three-dimensional objects to be obtained.

A fine powder has a large specific surface area per volume. Therefore, the fine powder has a larger contact point and a larger contact area between particles than a coarse powder. In a high-temperature, high-humidity environment, a liquid bridge force of water acts at the contact point between the particles and degrades the flowability of the powder. Here, the flowability of the fine powder is significantly degraded because the contact point and the contact area between the particles of the fine powder are large. The degradation of the flowability is expressed as degradation of the bulk density of the powder. The degradation of the bulk density of the powder leads to degradation of the density and degradation of the strength of the object produced in an object producing apparatus. As compared, the resin powder for producing a three-dimensional object of the present disclosure is suppressed from being affected by a liquid bridge force of water at the contact point between the particles and prevented from being degraded in the powder flowability in a high-temperature, high-humidity environment. This makes it possible to suppress degradation of the bulk density of the resin powder for producing a three-dimensional object and hence to improve the density and strength of the object produced.

<Average Equivalent Circle Diameter>

The average equivalent circle diameter (i.e., the average in an equivalent circle diameter-based particle size distribution) on a number base is 10 micrometers or greater but 150 micrometers or less, preferably 20 micrometers or greater but 90 micrometers or less, and more preferably 35 micrometers or greater but 60 micrometers or less. When the average equivalent circle diameter is 10 micrometers or greater but 150 micrometers or less, the resin powder, even if stored in a high-humidity environment, can provide a three-dimensional object to be obtained with an excellent density, an excellent dimensional stability, and an excellent surface property while preventing degradation of the strength. The average equivalent circle diameter can be measured with, for example, a particle image analyzing apparatus (apparatus name: FPIA3000, available from Spectris).

The equivalent circle diameter can be calculated according to the formula below.

Equivalent circle diameter=÷\sqrt{{4×(area)/π}} [Math.1]

The equivalent circle diameter is calculated based on a projection diagram of each individual particle. The average (number-base) of the calculated equivalent circle diameters can be calculated as an average equivalent circle diameter.

<Median in Equivalent Circle Diameter-Based Particle Size Distribution and Average in Equivalent Circle Diameter-Based Particle Size Distribution>

The resin powder for producing a three-dimensional object is a powder that scarcely includes minute mixed bodies, has particle diameters of the main constituent particles in a range of 30 micrometers or greater but 90 micrometers or less, and has the average in this range.

It is preferable that the median in the equivalent circle diameter-based particle size distribution be higher than the average equivalent circle diameter (i.e., the average in the equivalent circle diameter-based particle size distribution). When the median is higher than the average equivalent circle diameter, the resin powder can provide a three-dimensional object to be obtained with an excellent density, an excellent dimensional stability, and an excellent surface property while preventing degradation of the strength even if the resin powder has been stored in a high-humidity environment. In the equivalent circle diameter-based particle size distribution, when a mountain formed by concentrated distribution of particle diameters has a wide footing range, the median is present at a position close to the mountain whereas the average equivalent circle diameter is present at a position distant from the median because the average equivalent circle diameter is greatly affected by the footing. That is, when the median is higher than the average equivalent circle diameter, it is indicated that the mountain formed by concentrated distribution of main particle diameters is present at a high position, and that the mountain is not formed by minute particles. On the other hand, when the median is lower than the average equivalent circle diameter, it is indicated that the main mountain is formed by minute particles. This provides an indicator of which of minute particles and resin powder particles are the majority in the number distribution. To obtain the median in the equivalent circle diameter-based particle size distribution, images of particle shapes are acquired with a wet flow-type particle diameter/shape analyzer (apparatus name: FPIA-3000, available from Sysmex Corporation) when the number count of the powder particles is 3,000 or greater, and equivalent circle diameters of the particles having a particle diameter of 0.5 micrometers or greater but 200 micrometers or less are measured to obtain the particle size distribution. The median can be calculated from the particle size distribution.

<Average Circularity>

The average circularity is preferably 0.75 or higher but 0.90 or lower, and more preferably 0.75 or higher but 0.85 or lower. When the average circularity is 0.75 or higher but 0.90 or lower, the resin powder can provide a three-dimensional object to be obtained with an excellent density, an excellent dimensional stability, and an excellent surface property while preventing degradation of the strength even if the resin powder has been stored in a high-humidity environment.

The circularity is an indicator of closeness to a circle. A circularity of 1 indicates the highest closeness to a circle. The circularity is obtained according to the formula below where S represents an area (number of pixels) and L represents a perimeter.

Circularity=4πS/L² [Math.2]

To obtain the average circularity, circularities of the resin powder for producing a three-dimensional object may be measured, and the arithmetic mean of the measured circularities may be used as the average circularity.

A simple method for quantifying the circularity is to measure the circularity with, for example, a wet flow-type particle diameter/shape analyzer (apparatus name: FPIA3000, available from Sysmex Corporation). The wet flow-type particle diameter/shape analyzer can capture images of particles in a suspension flowing in a glass cell at a high speed with a CCD, and analyze individual particle images in real time. Such an apparatus that captures images of particles and performs image analyses is effective for obtaining the average circularity of the present disclosure. The number count of the particles to be measured is not particularly limited and is preferably 1,000 or greater and more preferably 3,000 or greater.

<Loose Filling Rate>

The loose filling rate is a value obtained by dividing a loose bulk density measured with a bulk specific gravity meter (compliant with JIS Z-2504, available from Kuramochi Scientific Instruments) with the true density of the resin.

The loose filling rate is preferably 20% or higher but 50% or lower and more preferably 30% or higher but 30% or lower. The loose filling rate can be obtained by measuring a loose density with a bulk specific gravity meter (compliant with JIS Z-2504, available from Kuramochi Scientific Instruments) and dividing the obtained loose density by the true density of the resin.

The resin powder for producing a three-dimensional object is preferably formed of columnar particles.

The columnar particles are not particularly limited and may be appropriately selected depending on the intended purpose. The columnar length is preferably 10 micrometers or greater but 150 micrometers or less, and the columnar diameter is preferably 10 micrometers or greater but 150 micrometers or less.

<Thermoplastic Resin>

The thermoplastic resin means a resin that is plasticized and melts upon heat application.

Examples of the thermoplastic resin include a crystalline resin. The crystalline resin means a resin that has a melting peak when measured according to ISO 3146 (a plastic transition temperature measuring method, JIS K7121).

The crystalline resin is not particularly limited and may be appropriately selected depending on the intended purpose. Examples of the crystalline resin include polymers such as polyolefin, polyamide, polyester, polyether, polyphenylene sulfide, liquid crystal polymers (LCP), polyacetal (POM), polyimide, and fluororesin. One of these crystalline resins may be used alone or two or more of these crystalline resins may be used in combination.

Examples of the polyolefin include polyethylene and polypropylene. One of these polyolefins may be used alone or two or more of these polyolefins may be used in combination.

Examples of the polyamide include: polyamide 410 (PA410), polyamide 6 (PA6), polyamide 66 (PA66), polyamide 610 (PA610), polyamide 612 (PA612), polyamide 11 (PA11), and polyamide 12 (PA12); and semi-aromatic polyamide 4T (PA4T), polyamide MXD6 (PAMXD6), polyamide 6T (PA6T), polyamide 9T (PA9T), and polyamide 10T (PA10T). One of these polyamides may be used alone or two or more of these polyamides may be used in combination.

Among these polyamides, PA9T is also called polynonamethylene terephthalamide, is formed of a diamine containing 9 carbon atoms and a terephthalic acid monomer, and is called semi-aromatic because the carboxylic acid-side is generally aromatic. Furthermore, what is called aramid, which is formed of p-phenylenediamine and a terephthalic acid monomer and is a fully aromatic series that is also aromatic on the diamine-side, is also encompassed within the polyamide of the present disclosure.

Examples of the polyester include polyethylene terephthalate (PET), polybutadiene terephthalate (PBT), and polylactic acid (PLA). An aromatic series-containing polyester that partially contains terephthalic acid or isophthalic acid in order to have heat resistance can also suitably used in the present disclosure.

Examples of the polyether include polyether ether ketone (PEEK), polyether ketone (PEK), polyether ketone ketone (PEKK), polyaryl ether ketone (PAEK), polyether ether ketone ketone (PEEKK), and polyether ketone ether ketone ketone (PEKEKK).

Any other crystalline polymers than the polyether can also be used. Examples of other crystalline polymers include polyacetal, polyimide, and polyether sulfone. A polymer having 2 melting point peaks, such as PA9T, may also be used (there is a need for raising the resin temperature to higher than or equal to the second melting point peak in order to completely melt the resin).

The resin powder for producing a three-dimensional object may also contain additives such as a resin powder formed of a non-crystalline resin, a toughening agent, a flame retardant, a plasticizer, a stabilizer, an antioxidant, and a nucleating agent in addition to the thermoplastic resin. One of these additives may be used alone or two or more of these additives may be used in combination. These additives may be mixed with the thermoplastic resin and contained within the resin powder for producing a three-dimensional object, or may be attached on the surface of the resin powder for producing a three-dimensional object.

The toughening agent is added in order to mainly increase the strength, and is added as a filler or a filling. Examples of the toughening agent include a glass filler, a glass bead, a carbon fiber, an aluminum ball, and the toughening agents described in International Publication No. WO 2008/057844. One of these toughening agents may be used alone or two or more of these toughening agents may be used in combination. The toughening agent may be contained in the resin. It is preferable that the resin powder of the present disclosure be in an appropriate dry state. It is possible to dry the resin powder before use by using a vacuum dryer or by adding silica gel.

Examples of the antioxidant include hydrazide types and amide types, which are metal deactivators, phenol types (hindered phenol-types) and amine types, which are radical scavengers, phosphate types and sulfur types, which are peroxide decomposers, and triazine types, which are ultraviolet absorbers. One of these antioxidants may be used alone or two or more of these antioxidants may be used in combination. Particularly, it is known to be effective to use a radical scavenger and a peroxide decomposer in combination. This combination is particularly effective also in the present disclosure.

The content of the antioxidant is preferably 0.05% by mass or greater but 5% by mass or less, more preferably 0.1% by mass or greater but 3% by mass or less, and particularly preferably 0.2% by mass or greater but 2% by mass or less relative to the total amount of the resin powder for producing a three-dimensional object. When the content of the antioxidant is in the range described above, a thermal degradation preventing effect can be obtained. This makes it possible for the resin powder for producing a three-dimensional object used for object production to be reused. Furthermore, a thermal discoloration preventing effect can also be obtained.

It is preferable that the resin powder for producing a three-dimensional object be a resin of which melting point measured according to ISO 3146 is 100 degrees C. or higher. It is preferable that the melting point of the resin powder measured according to ISO 3146 be 100 degrees C. or higher, because the melting point falls within the heat-resistant temperature range in which the resin powder can be used in, for example, an exterior of a product. The melting point can be used according to ISO 3146 (a plastic transition temperature measuring method, JIS K7121) by differential scanning calorimetry (DSC). When there are a plurality of melting points, the highest melting point is used.

As the crystalline resin, a crystallinity-controlled crystalline thermoplastic resin is preferable. The crystalline thermoplastic resin can be obtained by hitherto known methods for external stimulation, such as thermal treatment, stretching, a nucleating agent, and ultrasonic treatment. The crystalline thermoplastic resin having a controlled crystal size and a controlled crystal orientation is more preferable because such a crystalline thermoplastic resin can reduce errors that may occur during recoating at a high temperature.

The method for producing the crystalline thermoplastic resin is not particularly limited and may be appropriately selected depending on the intended purpose. Examples of the method include an annealing treatment for heating the powder at a temperature higher than or equal to the glass transition temperature of each resin to increase crystallinity, and a method of adding a nucleating agent to further increase crystallinity and subsequently applying an annealing treatment. Further examples include a method of increasing crystallinity by an ultrasonic treatment or by dissolution in a solvent and subsequent slow volatilization of the solvent, a method of growing a crystal by an external electric field applying treatment, and a method of further stretching the resin in order to be increased in orientation and crystallinity, and then applying machining such as pulverization and cutting to the resultant.

The annealing treatment can be performed by, for example, heating the resin at a temperature higher than the glass transition temperature by 50 degrees C. for 3 days, and subsequently slowly cooling the resin to room temperature.

The stretching is, for example, a method of drawing a resin melt to have the form of fibers with an extruder while stirring the resin melt at a temperature higher than the melting point by 30 degrees C. or more. Specifically, the melt is stretched to a size that is about 1 time or greater but 10 times or less larger to have the form of fibers. The larger the number of nozzle ports, the higher the productivity is expected to be. In the stretching, the maximum draw ratio may be varied depending on the resin and depending on the melt viscosity.

The ultrasonic treatment can be performed by, for example, adding a glycerin (available from Tokyo Chemical Industry Co., Ltd., reagent grade) solvent to the resin in an amount that is about 5 times higher than the amount of the resin, subsequently heating the resin to a temperature higher than the melting point by 20 degrees C., and then applying ultrasonic waves having a frequency of 24 kHz and an amplitude of 60% to the resin for 2 hours with an ultrasonic generator (available from Hielscher Ultrasonics GmbH, ULTRASONICATOR UP200S). Subsequently, it is preferable to wash the resin at room temperature with an isopropanol solvent and then subject the resin to vacuum drying.

The external electric field applying treatment can be performed by, for example, heating the resin powder at a temperature higher than or equal to the glass transition temperature, subsequently applying an alternating-current electric field of 600 V/cm (500 Hz) to the resin powder for 1 hour, and slowly cooling the resin powder.

Particularly in the PBF method among the powder lamination methods, a broad temperature width (temperature window) with respect to crystal layer changes is very effective because a crystal having a broad temperature window can be suppressed from being warped and can increase the object producing stability. Hence, it is preferable to use a resin powder having a greater difference between the melting start temperature and the recrystallization temperature during cooling. The crystalline thermoplastic resin is particularly suitable for use.

A resin can be identified as the crystalline thermoplastic resin when the resin satisfies at least one selected from the group consisting of (1) to (3) described below.

(1) In a differential scanning calorimetry measurement performed according to ISO 3146, a melting start temperature Tmf1 of an endothermic peak when the resin is heated at a rate of 10 degrees C./min to a temperature higher than the melting point by 30 degrees C. and a melting start temperature Tmf2 of an endothermic peak when the resin is subsequently cooled at a rate of 10 degrees C./min to lower than or equal to −30 degrees C. and then again heated at a rate of 10 degrees C./min to the temperature higher than the melting point by 30 degrees C. are in a relationship of Tmf1>Tmf2. The melting start temperature of the endothermic peak is a temperature lowered by −15 mW from a straight line that is drawn in parallel with the x-axis toward the low-temperature side from a position at which the calorific value becomes constant after the endotherm at the melting point is completed.

(2) In a differential scanning calorimetry measurement performed according to ISO 3146, a degree of crystallinity Cd1 obtained from an amount of energy of an endothermic peak when the resin is heated at a rate of 10 degrees C./min to a temperature higher than the melting point by 30 degrees C. and a degree of crystallinity Cd2 obtained from an amount of energy of an endothermic peak when the resin is subsequently cooled at a rate of 10 degrees C./min to lower than or equal to −30 degrees C. and then again heated at a rate of 10 degrees C./min to the temperature higher than the melting point by 30 degrees C. are in a relationship of Cd1>Cd2.

(3) A degree of crystallinity Cx1 obtained by an X-ray diffractometry measurement and a degree of crystallinity Cx2 obtained by an X-ray diffractometry measurement performed after the resin is heated at a rate of 10 degrees C./min to a temperature higher than the melting point by 30 degrees C., subsequently cooled at a rate of 10 degrees C./min to lower than or equal to −30 degrees C., and then again heated at a rate of 10 degrees C./min to the temperature higher than the melting point by 30 degrees C. in a nitrogen atmosphere are in a relationship of Cx1>Cx2.

(1) to (3) described above define the properties of the same resin powder from different viewpoints. (1) to (3) are related with one another. A resin that satisfies at least one of (1) to (3) is effective. (1) to (3) can be measured by, for example, the methods described below.

<Method for Measuring Melting Start Temperature by Differential Scanning Calorimetry in Condition (1)>

In the method for measuring the melting start temperature by differential scanning calorimetry (DSC) in the condition (1), a melting start temperature (Tmf1) of an endothermic peak when the resin is heated at a rate of 10 degrees C./min to a temperature higher than the melting point by 30 degrees C. is measured according to a measuring method of ISO 3146 (a plastic transition temperature measuring method, JIS K7121) with a differential scanning calorimeter (available from Shimadzu Corporation, DSC60A). Then, a melting start temperature (Tmf2) of an endothermic peak when the resin is subsequently cooled at a rate of 10 degrees C./min to lower than or equal to −30 degrees C. and then again heated at a rate of 10 degrees C./min to the temperature higher than the melting point by 30 degrees C. is measured. The melting start temperature of the endothermic peak is a temperature lowered by −15 mW from a straight line that is drawn in parallel with the x-axis toward the low-temperature side from a position at which the calorific value becomes constant after the endotherm at the melting point is completed.

<Method for Measuring Degree of Crystallinity by Differential Scanning Calorimetry in Condition (2)>

In the method for measuring the degree of crystallinity by differential scanning calorimetry (DSC) in the condition (2), an amount of energy (heat of fusion) of an endothermic peak when the resin is heated at a rate of 10 degrees C./min to a temperature higher than the melting point by 30 degrees C. is measured according to ISO 3146 (a plastic transition temperature measuring method, JISK7121). A degree of crystallinity (Cd1) can be obtained from the heat of fusion with respect to the perfect crystal heat of fusion. Then, an amount of energy of an endothermic peak when the resin is subsequently cooled at a rate of 10 degrees C./min to lower than or equal to −30 degrees C. and then again heated at a rate of 10 degrees C./min to the temperature higher than the melting point by 30 degrees C. is measured. A degree of crystallinity (Cd2) can be obtained from the heat of fusion with respect to the perfect crystal heat of fusion.

<Method for Measuring Degree of Crystallinity with X-Ray Analyzer in Condition (3)>

In the method for measuring the degree of crystallinity by an X-ray analyzer in the condition (3), an obtained powder is put on glass plate and a degree of crystallinity (Cx1) of the powder can be measured with an X-ray analyzer (available from Bruker Corp., DISCOVER 8) including a two-dimensional detector with the 20 range set to from 10 through 40 at room temperature. Next, in a DSC, the powder is heated at a rate of 10 degrees C./min to a temperature higher than the melting point by 30 degrees C., kept warm for 10 minutes, cooled at a rate of 10 degrees C./min to −30 degrees C. Subsequently, the sample is returned to room temperature, and a degree of crystallinity (Cx2) of the sample can be measured in the same manner as measuring Cx1.

The resin powder for producing a three-dimensional object can be used in the SLS method and the SMS method. The resin powder exhibits appropriately balanced properties in terms of parameters such as an appropriate particle size, a particle size distribution, a heat transfer characteristic, a melt viscosity, a bulk density, flowability, a melting temperature, and a recrystallization temperature.

In order to promote the degree of laser sintering in the PBF method, it is preferable that the resin powder for producing a three-dimensional object have a higher bulk density, although the resin intrinsically has variation in the density. The tap density of the resin powder is more preferably 0.35 g/mL or higher, yet more preferably 0.40 g/mL or higher, and particularly preferably 0.5 g/mL or higher.

A three-dimensional object to be produced by laser sintering with the use of the resin powder for producing a three-dimensional object is smooth and can be provided with a surface that exhibits a sufficient resolution lower than or equal to a minimum orange peel. Here, the orange peel generally refers to the presence of surface defect such as an inappropriate rough surface, or voids or distortion on the surface of a three-dimensional object produced by laser sintering in the PBF. For example, the voids not only spoil a beautiful appearance, but also may significantly affect the mechanical strength.

Furthermore, it is preferable that a three-dimensional object to be produced by laser sintering with the use of the resin powder for producing a three-dimensional object not exhibit improper process characteristics such as warpage, distortion, and fuming due to a phase change that occurs during cooling performed during and after sintering.

With the use of the resin powder for producing a three-dimensional object of the present disclosure, it is possible to obtain a three-dimensional object having a high dimensional accuracy, a high strength, and an excellent surface property (orange peel property). Moreover, the resin powder has an excellent recyclability, so repeated use of excess residual powder particles can be ensured suppression of degradation in the dimensional accuracy and strength of three-dimensional objects.

<Method for Producing Particles>

The resin powder for producing a three-dimensional object of the present disclosure may be obtained by, for example, a method of obtaining the resin in the form of fibers and then cutting the fibers to directly obtain approximately columnar particles (approximately cylindrical bodies or polygonal prism bodies), a method of obtaining similar columnar bodies from a film-shaped body, or a method of post-machining obtained polygonal prism particles into approximately cylindrical bodies after the production of the polygonal prism particles.

—Approximately Columnar Particles—

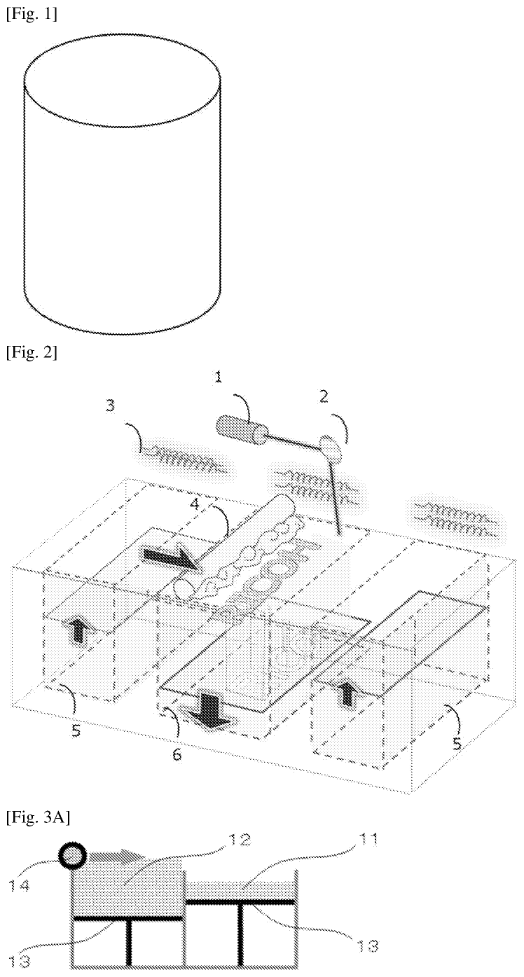

It is preferable that the resin powder for producing a three-dimensional object of the present disclosure include approximately columnar particles. The approximately columnar particles are particles having a columnar or tubular shape having a bottom surface and a top surface. The shape of the bottom surface and the top surface is not particularly limited and may be appropriately selected depending on the intended purpose, so the approximately columnar particles may be approximately cylindrical bodies or polygonal prism bodies. When the bottom surface and the top surface have a circular or elliptic shape, the approximately columnar particles are approximately cylindrical bodies (FIG. 1). When the bottom surface and the top surface have a polygonal shape such as a quadrangle shape or a hexagonal shape, the approximately columnar particles are polygonal prism bodies. So long as there is a columnar or tubular region between the bottom surface and the top surface, the bottom surface and the top surface may have the same shape or different shapes. The approximately columnar particles may be straight columnar bodies of which columnar portion (side surfaces) is orthogonal to the bottom surface and the top surface, or may be diagonal columnar bodies of which columnar portion is not orthogonal to the bottom surface and the top surface.

The resin powder having the approximately columnar shape can provide a powder that has a small repose angle and has a high powder surface smoothness during recoating. This can provide a three-dimensional object to be obtained with an improved surface property. It is more preferable that the approximately columnar body be closer to a straight columnar body of which bottom surface and top surface are approximately parallel with each other, in terms of productivity and object producing stability. The approximately columnar shape can be discerned by observation with, for example, a scanning electron microscope (apparatus name: S4200, available from Hitachi, Ltd.) or a wet flow-type particle diameter/shape analyzer (apparatus name: FPIA-3000, available from Sysmex Corporation).

The content of the approximately columnar particles is preferably 50% or greater, more preferably 75% or greater, and particularly preferably 90% or greater relative to the total amount of the resin powder for producing a three-dimensional object. When the content of the approximately columnar particles is 50% or greater, there is an apparent effect of increasing the packing density. This is very effective for improving the dimensional accuracy and strength of the three-dimensional object to be obtained.

—Approximately Cylindrical Body—

The approximately cylindrical body is not particularly limited and may be appropriately selected depending on the intended purpose. Examples of the approximately cylindrical body include a true cylindrical body and an elliptic cylindrical body. Of these approximately cylindrical bodies, one that is closer to a true cylindrical body is more preferable. The approximately cylindrical body is referred to as “approximately cylindrical” when the ratio of the longer diameter to the shorter diameter (longer diameter/shorter diameter) is from 1 through 10. A cylindrical body having a partially chipped circular shape is also encompassed within the approximately cylindrical body.

It is preferable that the approximately cylindrical body have approximately circular facing surfaces. The facing surfaces may have different circle diameters. However, the ratio of the circle diameter of the larger surface to the circle diameter of the smaller surface (larger surface/smaller surface) is preferably 1.5 or lower and more preferably 1.1 or lower in terms of effectiveness in increasing the density.

The longer side of the bottom surface of the approximately cylindrical body is not particularly limited, may be appropriately selected depending on the intended purpose, and may have a length of 5 micrometers or greater but 200 micrometers or less. The longer side of the bottom surface of the approximately cylindrical particles refers to the diameter of the bottom surface. When the circular portion of the approximately cylindrical particles has an elliptic shape, the longer side refers to the longer diameter. The height of the approximately cylindrical body (i.e., the distance between the bottom surface and the top surface) is not particularly limited, may be appropriately selected depending on the intended purpose, and is preferably 5 micrometers or greater but 200 micrometers or less. When the longer side of the bottom surface is in the range, the resin powder can be suppressed from curling up during formation of a powder layer. This makes the surface of the powder layer smooth and reduces voids to be formed between the resin powder particles, leading to an effect of further improving the surface property and the dimensional accuracy of the three-dimensional object.

The resin powder may contain particles of which bottom surface longer side and of which height are less than 5 micrometers, or greater than 200 micrometers. However, it is preferable that the content of such particles be lower. Specifically, it is preferable that particles of which bottom surface longer side and of which height are 5 micrometers or greater but 200 micrometers or less account for 50% or greater and more preferably 75% or greater of all particles.

Examples of the method for making the form of fibers include a method of drawing a resin melt to have the form of fibers with an extruder while stirring the resin melt at a temperature higher than the melting point by 30 degrees C. or more. Here, it is preferable the resin melt be stretched to a size that is about 1 time or greater but 10 times or less larger to have the form of fibers. In this case, the shape of the bottom surface of the columnar body is determined by the shape of the nozzle ports of the extruder. For example, when the shape of the bottom surface of the columnar body, i.e., the cross-sectional shape of a fiber is a circular shape, nozzle ports having a circular shape are used. When the shape of the bottom surface of the columnar body is a polygonal shape, nozzle ports are selected in accordance with the polygonal shape. It is preferable that a three-dimensional object have the highest possible dimensional accuracy. It is preferable that the number of nozzle ports be the possible maximum in terms of increasing the productivity.

Examples of the method for cutting the fibers include a guillotine-type cutting apparatus bladed on both of the upper and lower sides, and a so-called press-cutting apparatus having a plate instead of a blade on the lower side and configured to cut an article with an upper blade. Hitherto known apparatuses of these types may be used. Examples of hitherto known apparatuses of these types include an apparatus configured to directly cut an article into a size of 0.005 mm or greater but 0.2 mm or less, and a method of cutting an article with, for example, a CO₂ laser. These apparatuses are suitable for use. With these methods, the resin powder for producing a three-dimensional object of the present disclosure can be obtained.

A method for pulverizing pellets of the resin is also effective for use. For example, the resin in the form of, for example, pellets, is mechanically pulverized with a hitherto known pulverizer, and particles other than particles having the intended particle diameter are classified and removed. The temperature during pulverization is preferably 0 degrees C. or lower (lower than or equal to the brittleness temperature of the resin), more preferably −25 degrees C. or lower, and particularly preferably −100 degrees C. or lower. These temperatures are effective because the pulverization efficiency is increased.

The resin powder for producing a three-dimensional object of the present disclosure is useful for producing a three-dimensional product with the use of, for example, laser sintering methods according to a PBF method such as a selective laser sintering (SLS) method or a selective mask sintering (SMS) method.

(Three-Dimensional Object Producing Method and Three-Dimensional Object Producing Apparatus)

A three-dimensional object producing method of the present disclosure includes a layer forming step of forming a layer of the resin powder for producing a three-dimensional object of the present disclosure and a powder adhesion step of irradiating a selected region of the formed layer with an electromagnetic wave to make particles of the resin powder adhere to each other. The three-dimensional object producing method repeats the layer forming step and the powder adhesion step. The three-dimensional object producing method further includes other steps as needed.

The three-dimensional object producing apparatus includes a layer forming unit configured to form a layer of the resin powder of the present disclosure and a powder adhesion unit configured to make particles of the resin powder for producing a three-dimensional object in a selected region of the layer adhere to each other, and further includes other units as needed.

The three-dimensional object producing method can be favorably performed with the use of the three-dimensional object producing apparatus. As the resin powder for producing a three-dimensional object, a similar resin powder to the resin powder for producing a three-dimensional object of the present disclosure can be used.

The resin powder for producing a three-dimensional object can be used in, and is effective for all three-dimensional object producing apparatuses of the powder lamination type. The three-dimensional object producing apparatuses of the powder lamination type are varied in the unit configured to make particles of the resin powder in the selected region adhere to each other after formation of the powder layer, and examples of the unit include an electromagnetic irradiation unit typically represented by the SLS system and the SMS system, and a liquid discharging unit represented by a binder jetting system. The resin powder for producing a three-dimensional object of the present disclosure can be used in all of these systems, and is effective for all three-dimensional object producing apparatuses that include a powder lamination unit.

The powder adhesion unit is not particularly limited and may be appropriately selected depending on the intended purpose. Examples of the powder adhesion unit include a unit configured to perform electromagnetic wave irradiation.

In the three-dimensional object producing apparatuses of, for example, the SLS type and the SMS type employing electromagnetic wave irradiation, examples of an electromagnetic irradiation source used for electromagnetic wave irradiation include lasers for irradiation of, for example, ultraviolet rays, visible light rays, and infrared rays, microwaves, discharges, electron beams, radiative heaters, and LED lamps, or any combinations of these sources.

In the case of employing electromagnetic wave irradiation as a method for making particles of the resin powder for producing a three-dimensional object adhere to each other selectively, there is an option of employing a method of promoting efficient absorption or disturbing absorption. For example, it is possible to employ a method of adding an absorber or a suppressant in the resin powder.

An example of such a three-dimensional object producing apparatus will be described with reference to FIG. 2. FIG. 2 is a schematic diagram illustrating an example of the three-dimensional object producing apparatus. As illustrated in FIG. 2, the powder is stored in a powder supplying tank 5, and supplied to a laser scanning space 6 with the use of a roller 4 in accordance with the amount of use. It is preferable that the supplying tank 5 be temperature-adjusted by a heater 3. The laser scanning space 6 is irradiated with a laser output from an electromagnetic irradiation source 1 via a reflecting mirror 2. The powder is sintered by heat of the laser. As a result, a three-dimensional object can be obtained.

The temperature of the supplying tank 5 is preferably lower than the melting point of the powder by 10 degrees C. or more.

The temperature of the part bed in the laser scanning space is preferably lower than the melting point of the powder by 5 degrees C. or more.

The laser power is not particularly limited, may be appropriately selected depending on the intended purpose, and is preferably 10 watts or higher but 150 watts or lower.

In another embodiment, a three-dimensional object of the present disclosure can be produced with the use of a selective mask sintering (SMS) technique. As the SMS process, one that is described in, for example, U.S. Pat. No. 6,531,086 is suitable for use.

In the SMS process, a shielding mask is used to selectively block infrared radiation and selectively irradiate a part of a powder layer with an infrared ray. In the case of using the SMS process for producing a three-dimensional object with the resin powder for producing a three-dimensional object of the present disclosure, it is possible and effective to add a material that enhances the infrared absorption property of the resin powder. For example, it is possible to add one or more kinds of heat absorbers or one or more kinds of dark materials (for example, carbon fiber, carbon black, carbon nanotube, or carbon fiber and cellulose nanofiber) or both of one or more kinds of heat absorbers and one or more kinds of dark materials.

In yet another embodiment, a three-dimensional object can be produced with the use of the resin powder for producing a three-dimensional object of the present disclosure and a three-dimensional object producing apparatus of the binder jetting type. This method includes a layer forming step of forming a layer of the resin powder for producing a three-dimensional object of the present disclosure and a powder adhesion step of discharging a liquid to a selected region of the formed layer and drying the liquid to make particles of the resin powder adhere to each other. This method repeats the layer forming step and the powder adhesion step. This method further includes other steps as needed.

The three-dimensional object producing apparatus includes a layer forming unit configured to form a layer of the resin powder for producing a three-dimensional object of the present disclosure and a unit configured to discharge a liquid to a selected region of the formed layer, and further includes other units as needed. The unit configured to discharge a liquid is preferably of an inkjet type, in terms of the dimensional accuracy of a three-dimensional object to be obtained and an object producing speed.

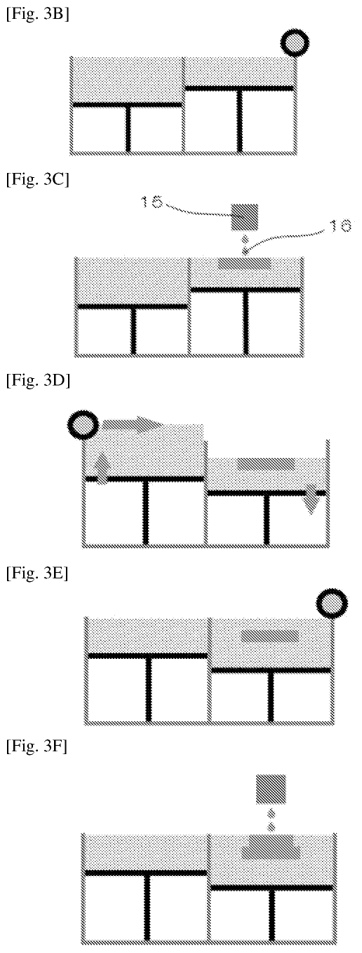

FIG. 3 illustrate an example of schematic diagrams of a binder jetting-type process. The three-dimensional object producing apparatus illustrated in FIG. 3 includes a forming-side powder storing tank 11 and a supplying-side powder storing tank 12. Each of the powder storing tanks includes a state 13 movable upward and downward. With the resin powder of the present disclosure placed on the stage 13, a layer of the resin powder for producing a three-dimensional object is formed. Above the forming-side powder storing tank 11, the three-dimensional object producing apparatus includes a three-dimensional object producing liquid material supplying unit 15 configured to discharge a liquid material 16 for producing a three-dimensional object toward the resin powder for producing a three-dimensional object in the powder storing tank, and further includes a resin powder layer forming unit 14 (hereinafter may also be referred to as leveling mechanism or recoater) capable of supplying the resin powder for producing a three-dimensional object from the supplying-side powder storing tank 12 to the forming-side powder storing tank 11 and leveling the surface of the resin powder (layer) in the forming-side powder storing tank 11.

FIG. 3A and FIG. 3B illustrate a step of supplying the resin powder from the supplying-side powder storing tank 12 to the forming-side powder storing tank 11 and forming a resin powder layer having a smooth surface. The stages 13 of the forming-side powder storing tank 11 and the supplying-side powder storing tank 12 are controlled to have a gap that enables a desired layer thickness, and the resin powder layer forming unit 14 is moved from the supplying-side powder storing tank 12 to the forming-side powder storing tank 11. In this way, a resin powder layer is formed in the forming-side powder storing tank 11.

FIG. 3C illustrates a step of dropping the liquid material 16 for producing a three-dimensional object onto the resin powder layer in the forming-side powder storing tank 11 with the use of the object producing liquid supplying unit 15. Here, the position to which the liquid material 16 for producing a three-dimensional object is dropped on the resin powder layer is determined based on two-dimensional image data (slice data) representing many planer layers into which a three-dimensional object is sliced.

In FIG. 3D and FIG. 3E, the stage 13 of the supplying-side powder storing tank 12 is lifted up, and the stage 13 of the forming-side powder storing tank 11 is lifted down, to control the gap that enables the desired layer thickness. The resin powder layer forming unit 14 is again moved from the supplying-side powder storing tank 12 to the forming-side powder storing tank 11. In this way, a new resin powder layer is formed in the forming-side powder storing tank 11.

FIG. 3F illustrates a step of dropping the liquid material 16 for producing a three-dimensional object again onto the resin powder layer in the forming-side powder storing tank 11 with the use of the three-dimensional object producing liquid material supplying unit 15. These series of steps are repeated, and drying is performed as needed in order to remove resin powder particles (excess powder particles) to which the liquid material for producing a three-dimensional object is not attached. In this way, a three-dimensional object can be obtained.

It is preferable to add an adhesive in order to make the resin powder particles adhere to each other. The adhesive may be added in the state of being dissolved in the liquid to be discharged, or may be mixed in the resin powder in the form of adhesive particles. It is preferable to dissolve the adhesive in the liquid to be discharged. For example, when the liquid to be discharged contains water as the main component, it is preferable that the adhesive be water-soluble.

Examples of water-soluble adhesives include polyvinyl alcohol (PVA), polyvinyl pyrrolidone, polyamide, polyacrylamide, polyethyleneimine, polyethylene oxide, polyacrylic acid resins, cellulose resins, and gelatin. Among these water-soluble adhesives, polyvinyl alcohol is more preferable for use in order to increase the strength and dimensional accuracy of a three-dimensional object.

The resin powder for producing a three-dimensional object of the present disclosure has a high flowability and can hence improve the surface property of a three-dimensional object to be obtained. This effect is not limited to the method using electromagnetic irradiation, but also works in all three-dimensional object producing apparatuses using the powder lamination method such as the binder jetting method.

(Three-Dimensional Object)

The three-dimensional object can be favorably produced according to the three-dimensional object producing method of the present disclosure.

### EXAMPLES

The present disclosure will be more specifically described by way of Examples. The present disclosure should not be construed as being limited to these Examples.

“Average equivalent circle diameter, average circularity, and median in equivalent circle diameter-based particle size distribution” and “loose filling rate” of the obtained resin powders for producing a three-dimensional object were measured in the manners described below. The results are presented in Table 1 below.

<Average Equivalent Circle Diameter, Average Circularity, and Median in Equivalent Circle Diameter-Based Particle Size Distribution>

For the average equivalent circle diameter and the average circularity, images of particle shapes were acquired with a wet flow-type particle diameter/shape analyzer (apparatus name: FPIA-3000, available from Sysmex Corporation) when the number count of the powder particles was 3,000 or greater, and equivalent circle diameters and circularities of the particles having a particle diameter of 0.5 micrometers or greater but 200 micrometers or less were measured, and the average of the equivalent circle diameters and the average of the circularities were calculated. The circularity measurement was performed twice, and the average of the two measurements was used as the average circularity. The median was calculated from the equivalent circle diameter-based particle size distribution.

<Loose Filling Rate>

For the loose filling rate, a loose density was measured with a bulk specific gravity meter (compliant with JIS Z-2504, available from Kuramochi Scientific Instruments). The obtained loose density was divided by the true density of the resin, to calculate “loose filling rate” of the powder.

### Example 1

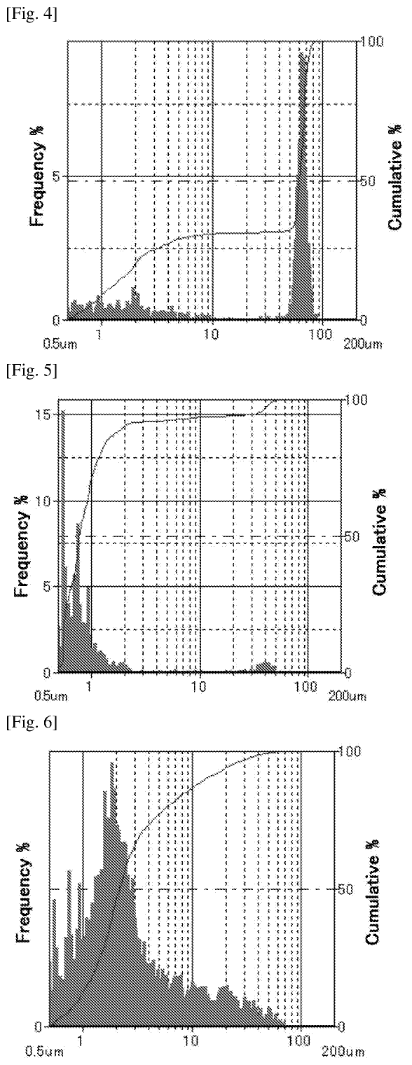

A polybutylene terephthalate (PBT) resin (product name: NOVADURAN 5020, available from Mitsubishi Engineering-Plastics Corporation, with a melting point of 218 degrees C. and a glass transition temperature of 43 degrees C.) was stirred at a temperature higher than the melting point by 30 degrees C. Subsequently, the solution in which the resin for producing a three-dimensional object was dissolved was stretched to have the form of fibers with an extruder (available from Japan Steel Works, Ltd.) using nozzle ports having a circular shape. This operation was performed with the number of strings to be extruded from the nozzles set to 60 strings. The solution was stretched to a size that was about 5 times larger such that the diameter of the fibers would be 55 micrometers in a manner that fibers with an accuracy of ±4 micrometers would be obtained and then adjusted to 55 micrometers, and the fibers were cut with a press-cutting apparatus (available from Ogino Seiki Co., Ltd., NJ SERIES 1200 TYPE) at an intended length of 55 micrometers, to obtain approximately cylindrical particles, which were used as the resin powder for producing a three-dimensional object. Cross-sections resulting from the cutting were observed with a scanning electron microscope (apparatus name: S4200, available from Hitachi, Ltd.) at a magnification of ×300. As a result, the cross-sections were neatly cut, and the cut surfaces were parallel with each other. The height of the approximately cylindrical bodies was measured. As a result, it was found possible to achieve an accuracy of 55 micrometers±10 micrometers by the cutting. The obtained resin powder for producing a three-dimensional object was passed through a sieve having a mesh size of 125 micrometers, to remove coarse particles due to a partial cutting failure. FIG. 4 illustrates the distribution of equivalent circle diameters of the resin powder for producing a three-dimensional object of Example 1.

### Example 2

A resin powder for producing a three-dimensional object was obtained in the same manner as in Example 1, except that the polybutylene terephthalate (PBT) resin of Example 1 was changed to a polyamide 66 (PA66) resin (product name: LEONA 1300S, available from Asahi Kasei Chemicals Corporation, with a melting point of 265 degrees C.), the intended fiber diameter was set to 140 micrometers, and the intended fiber length was set to 140 micrometers.

### Example 3

A resin powder for producing a three-dimensional object was obtained in the same manner as in Example 1, except that the polybutylene terephthalate (PBT) resin of Example 1 was changed to a polyamide 9T (PA9T) resin (product name: GENESTAR N1000A, available from Kuraray Co., Ltd., with a melting point of 306 degrees C.), the intended fiber diameter was set to 15 micrometers, and the intended fiber length was set to 15 micrometers.

### Example 4

A resin powder for producing a three-dimensional object was obtained in the same manner as in Example 1, except that the polybutylene terephthalate (PBT) resin of Example 1 was changed to a polypropylene (PP) resin (product name: NOVATEC MA3, available from Japan Polypropylene Corporation, with a melting point of 130 degrees C. and a glass transition temperature of 0 degrees C.), the intended fiber diameter was set to 55 micrometers, and the intended fiber length was set to 55 micrometers.

### Example 5

A resin powder for producing a three-dimensional object was obtained in the same manner as in Example 1, except that the polybutylene terephthalate (PBT) resin of Example 1 was changed to a polyether ether ketone (PEEK) resin (product name: HT P22PF, available from VICTREX PLC, with a melting point of 334 degrees C. and a glass transition temperature of 143 degrees C.), the intended fiber diameter was set to 55 micrometers, and the intended fiber length was set to 55 micrometers.

### Example 6

A resin powder for producing a three-dimensional object was obtained in the same manner as in Example 1, except that the polybutylene terephthalate (PBT) resin was changed to a polyacetal (POM) resin (product name: IUPITAL F10-01, available from Mitsubishi Engineering-Plastics Corporation, with a melting point of 175 degrees C.), the intended fiber diameter was set to 55 micrometers, and the intended fiber length was set to 55 micrometers.

### Example 7

The resin powder for producing a three-dimensional object obtained in Example 1 was subjected to stirring treatment in a stainless-steel container. The stirring treatment was performed for 30 minutes in a stainless-steel container available from Misugi Co., Ltd.

The relationship between the weight of the resin powder for producing a three-dimensional object put in the stainless-steel container and the area of the internal wall of the container was 1 [kg/m²]. After this operation, the powder was gravitationally transferred to another container, and powder particles attached to the wall surface were detached and disposed of. Through these operations, a resin powder for producing a three-dimensional object of Example 7 was obtained.

### Example 8

The resin powder for producing a three-dimensional object obtained in Example 4 was subjected to stirring treatment in a stainless-steel container in the same manner as in Example 7, to obtain a resin powder for producing a three-dimensional object of Example 8.

### Example 9

The resin powder for producing a three-dimensional object obtained in Example 1 was passed through an air conveying system. The duct was formed of stainless steel. The relationship between the weight of the resin powder for producing a three-dimensional object passed through the air conveying system formed of stainless steel and the area of the internal wall of the container was 1 [kg/m²]. Powder particles attached to the wall surface through this operation were detached and disposed of. Through this operation, a resin powder for producing a three-dimensional object of Example 9 was obtained.

### Example 10

The resin powder for producing a three-dimensional object obtained Example 4 was subjected to stirring treatment in a stainless-steel container in the same manner as in Example 9, to obtain a resin powder for producing a three-dimensional object of Example 10.

### Comparative Example 1

A resin powder for producing a three-dimensional object was obtained in the same manner as in Example 1, except that unlike in Example 1, no operation for forming particles by machining was performed, but a powder material formed of PA12 (product name: ASPEX-PA, available from Aspect Inc.) was used. FIG. 5 illustrates the distribution of equivalent circle diameters of the resin powder for producing a three-dimensional object of Comparative Example 1.

### Comparative Example 2

A resin powder for producing a three-dimensional object was obtained in the same manner as in Example 1, except that unlike in Example 1, no operation for forming particles by machining was performed, but a powder material formed of PAH (product name: ASPEX-FPA, available from Aspect Inc.) was used. FIG. 6 illustrates the distribution of equivalent circle diameters of the resin powder for producing a three-dimensional object of Comparative Example 2.

### Comparative Example 3

A resin powder for producing a three-dimensional object was obtained in the same manner as in Example 1, except that unlike in Example 1, no operation for forming particles by machining was performed, but a powder material formed of PPS (product name: ASPEX-PPS, available from Aspect Inc.) was used.

### Comparative Example 4

A resin powder for producing a three-dimensional object was obtained in the same manner as in Example 1, except that unlike in Example 1, the polybutylene terephthalate (PBT) resin was frozen-crushed at −200 degrees C. with a cryogenic grinding system (apparatus name: LINREX MILL LX1, available from Hosokawa Micron Corporation), to obtain a resin powder for producing a three-dimensional object.

The obtained resin powders for producing a three-dimensional object were evaluated in terms of “dimensional accuracy”, “surface property (orange peel property)”, “tensile strength”, and “object density” in the manners described below. The results are presented in Table 1 below.

(Dimensional Accuracy)

The obtained resin powder for producing a three-dimensional object was stored in an environment having a temperature of 27 degrees C. and a humidity of 80% RH for 1 week. A three-dimensional object was produced with the use of the resin powder for producing a three-dimensional object after stored for 1 week, and a SLS-type three-dimensional object producing apparatus (available from Ricoh Company, Ltd., AM S5500P). Set conditions include a powder layer average thickness of 0.1 mm, a laser power of 10 watts or higher but 150 watts or lower, a laser scanning space of 0.1 mm, and a bed temperature of −3 degrees C. from the melting point of the resin.

The sample for dimensional accuracy evaluation was a cuboid having a length of 50 mm on each side and an average thickness of 5 mm. A three-dimensional object was produced based on CAD data and used as the sample for dimensional accuracy evaluation. Differences between the length of each side of the CAD data for the sample for dimensional accuracy evaluation and the length of each side of the actually produced sample were calculated and averaged as a dimensional difference. “Dimensional accuracy” was evaluated according to the evaluation criteria described below.

<Evaluation Criteria>

A: The dimensional difference was 0.02 mm or less.

B: The dimensional difference was greater than 0.02 mm but 0.05 mm or less.

C: The dimensional difference was greater than 0.05 mm but 0.10 mm or less.

D: The dimensional difference was greater than 0.10 mm and 0.15 mm or less.

(Surface Property (Orange Peel Property))

The surface of the three-dimensional object sample used for the evaluation of “dimensional accuracy” was subjected to visual observation, optical microscope observation, and a sensory analysis. In the sensory analysis, the sample was touched by a hand, and the surface property, particularly, smoothness was evaluated based on the tactile impression felt. The results were summed to evaluate the surface property (orange peel property) according to the evaluation criteria described below.

<Evaluation Criteria>

A: The surface was very smooth and had almost no conspicuous bumpiness or roughness.

B: The surface had a non-problematic smoothness and tolerable surface bumpiness or roughness.

C: The surface was not smooth and had visible bumpiness and roughness.

D: The surface was scratchy and had many defects such as surface bumpiness and distortion.

(Tensile Strength)

As in the “dimensional accuracy” evaluation, with the use of the resin powder for producing a three-dimensional object after stored for 1 week, and with the same apparatus and the same conditions as in the production of the sample for dimensional accuracy evaluation, 5 tensile test specimen samples were produced such that the samples were arranged side by side with the samples' longer direction parallel with a Y-axis direction and with the samples' center positioned on the Y-axis direction. The interval between the object layers was 5 mm. For the tensile test specimen samples, a Type 1A multipurpose dog bone-like test specimen compliant with ISO (International Organization for Standardization) 3167 (the specimen having a center portion having a length of 80 mm, a thickness of 4 mm, and a width of 10 mm) was used.

The tensile strength of the obtained tensile test specimen samples (three-dimensional objects) was measured with the use of a tensile tester compliant with ISO 527 (available from Shimadzu Corporation, AGS-5KN). The testing speed in the tensile test was 50 mm/minute. Based on the average of the tensile strength values of the obtained 5 tensile test specimen samples, the tensile strength evaluation was performed according to the evaluation criteria described below.

<Evaluation Criteria>

A: The tensile strength was 100 MPa or higher.

B: The tensile strength was 50 MPa or higher but lower than 100 MPa

C: The tensile strength was 30 MPa or higher but lower than 50 MPa.

D: The tensile strength was lower than 30 MPa.

(Object Density)

The three-dimensional object sample used for the evaluation of “dimensional accuracy” was measured according to the Archimedes method (apparatus name: AD1653/AD-1654, available from A&D Company, Ltd.). Ion-exchanged water was used as a sample solvent. The measurement was performed with care taken not for bubbles to be attached to the circumference of the sample.

TABLE 1

| | Resin powder for producing three-dimensional object | | | | | | | | |
|---|---|---|---|---|---|---|---|---|---|
| | | | Median in | | | | | | |
| | | Average | equivalent | | | | | | |
| | | equivalent | circle diameter- | | | | | | |
| | | circle | based particle | | Loose | Evaluation result | | | |
| | | diameter | size distribution | Average | filling | Object | Dimensional | Surface | Tensile |
| | Resin | (micrometer) | (micrometer) | circularity | rate (%) | density | accuracy | property | strength |
| Ex. 1 | PBT | 46.0 | 62.66 | 0.83 | 32.4 | 96.7 | A | A | B |
| Ex. 2 | PA66 | 146.3 | 156.20 | 0.76 | 33.4 | 95.7 | A | B | A |
| Ex. 3 | PA9T | 13.6 | 25.60 | 0.82 | 32.6 | 96.6 | B | A | B |
| Ex. 4 | PP | 51.2 | 59.50 | 0.81 | 38.4 | 95.4 | B | B | A |
| Ex. 5 | PEEK | 62.1 | 78.30 | 0.80 | 37.4 | 95.6 | A | B | A |
| Ex. 6 | POM | 65.1 | 71.20 | 0.84 | 36.5 | 95.7 | A | B | B |
| Ex. 7 | PBT | 65.7 | 68.40 | 0.82 | 43.5 | 98.7 | A | A | B |
| Ex. 8 | PP | 58.6 | 60.50 | 0.81 | 42.4 | 96.6 | B | B | A |
| Ex. 9 | PBT | 64.1 | 66.80 | 0.82 | 42.1 | 97.2 | A | A | B |
| Ex. 10 | PP | 56.3 | 60.10 | 0.81 | 40.4 | 96.1 | B | B | A |
| Comp. Ex. 1 | PA12 | 3.3 | 0.96 | 0.94 | 15.9 | 78.9 | C | C | C |
| Comp. Ex. 2 | PA11 | 5.3 | 2.22 | 0.91 | 25.7 | 86.4 | C | B | C |
| Comp. Ex. 3 | PPS | 25.4 | 16.01 | 0.87 | 14.6 | 83.1 | C | C | C |
| Comp. Ex. 4 | PBT | 1.2 | 2.50 | 0.77 | 31.5 | 81.5 | C | D | C |

Aspects of the present disclosure are as follows, for example.

<1> A resin powder for producing a three-dimensional object,

wherein the resin powder has a number-average equivalent circle diameter of 10 micrometers or greater but 150 micrometers or less, and

wherein a median in an equivalent circle diameter-based particle size distribution of the resin powder is higher than an average in the equivalent circle diameter-based particle size distribution.

<2> The resin powder for producing a three-dimensional object according to <1>,

wherein particles of the resin powder include columnar particles.

<3> The resin powder for producing a three-dimensional object according to <2>,

wherein the columnar particles have a cylindrical length of 10 micrometers or greater but 150 micrometers or less and a cylindrical diameter of 10 micrometers or greater but 150 micrometers or less.

<4> The resin powder for producing a three-dimensional object according to any one of <1> to <3>,

wherein the resin powder has an average circularity of 0.75 or higher but 0.90 or lower.

<5> The resin powder for producing a three-dimensional object according to any one of <1> to <4>, the resin powder including

a crystalline resin,
wherein the crystalline resin is at least one selected from the group consisting of polyolefin, polyamide, polyester, polyaryl ketone, and polyphenylene sulfide.

<6> The resin powder for producing a three-dimensional object according to <5>,

wherein the polyester is at least one selected from the group consisting of polyethylene terephthalate, polybutadiene terephthalate, and polylactic acid.

<7> The resin powder for producing a three-dimensional object according to <5> or <6>,

wherein the polyolefin is polyethylene or polypropylene.

<8> The resin powder for producing a three-dimensional object according to any one of <1> to <7>, the resin powder further including

an antioxidant.

<9> The resin powder for producing a three-dimensional object according to <8>,

wherein a content of the antioxidant is 0.05% by mass or greater but 5% by mass or less.

<10> The resin powder for producing a three-dimensional object according to <9>,

wherein the content of the antioxidant is 0.1% by mass or greater but 3% by mass or less.

<11> The resin powder for producing a three-dimensional object according to <10>,

wherein the content of the antioxidant is 0.2% by mass or greater but 2% by mass or less.

<12> The resin powder for producing a three-dimensional object according to any one of <1> to <11>, the resin powder further including

a plasticizer.

<13> The resin powder for producing a three-dimensional object according to any one of <1> to <12>, the resin powder further including

a stabilizer.

<14> The resin powder for producing a three-dimensional object according to any one of <1> to <13>, the resin powder further including

a nucleating agent.

<15> The resin powder for producing a three-dimensional object according to any one of <1> to <14>, the resin powder further including

a toughening agent

<16> The resin powder for producing a three-dimensional object according to <15>,

wherein the toughening agent is at least one selected from the group consisting of a glass filler, a glass bead, a carbon fiber, and an aluminum ball.

<17> The resin powder for producing a three-dimensional object according to <16>,

wherein the toughening agent is at least any one of a glass filler and a carbon fiber.

<18> The resin powder for producing a three-dimensional object according to <17>,

wherein the toughening agent is a carbon fiber.

<19> A three-dimensional object producing method including:

a layer forming step of forming a layer including the resin powder for producing a three-dimensional object according to any one of <1> to <18>; and
a powder adhesion step of making particles of the resin powder for producing a three-dimensional object in a selected region of the layer adhere to each other,
wherein the three-dimensional object producing method repeats the layer forming step and the powder adhesion step.

<20> A three-dimensional object producing apparatus including:

a layer forming unit configured to form a layer including the resin powder for producing a three-dimensional object according to any one of <1> to <18>; and
a powder adhesion unit configured to make particles of the resin powder for producing a three-dimensional object in a selected region of the layer adhere to each other.

<21> The three-dimensional object producing apparatus according to <20>,

wherein the powder adhesion unit is a unit configured to perform electromagnetic wave irradiation.
<22> A three-dimensional object produced according to the three-dimensional object producing method according to <19>.

The resin powder for producing a three-dimensional object according to any one of <1> to <18>, the three-dimensional object producing method according to <19>, the three-dimensional object producing apparatus according to <20> or <21>, and the three-dimensional object according to <22> can solve the various problems in the related art and can achieve the object of the present disclosure.

1. A resin powder for producing a three-dimensional object,
wherein the resin powder has a number-average equivalent circle diameter of 10 micrometers or greater but 150 micrometers or less, and
wherein a median in an equivalent circle diameter-based particle size distribution of the resin powder is higher than the average equivalent circle diameter.

2. The resin powder for producing a three-dimensional object according to claim 1,
wherein particles of the resin powder comprise columnar particles.

3. The resin powder for producing a three-dimensional object according to claim 2,
wherein the columnar particles have a cylindrical length of 10 micrometers or greater but 150 micrometers or less and a cylindrical diameter of 10 micrometers or greater but 150 micrometers or less.

4. The resin powder for producing a three-dimensional object according to claim 1,
wherein the resin powder has an average circularity of 0.75 or higher but 0.90 or lower.

5. The resin powder for producing a three-dimensional object according to claim 1, the resin powder comprising
a crystalline resin,
wherein the crystalline resin comprises at least one selected from the group consisting of polyolefin, polyamide, polyester, polyaryl ketone, and polyphenylene sulfide.

6. The resin powder for producing a three-dimensional object according to claim 5,
wherein the polyester comprises at least one selected from the group consisting of polyethylene terephthalate, polybutadiene terephthalate, and polylactic acid.

7. A three-dimensional object producing method comprising:
forming a layer that comprises a resin powder for producing a three-dimensional object; and
making particles of the resin powder for producing a three-dimensional object in a selected region of the layer adhere to each other,
wherein the three-dimensional object producing method repeats the forming and the adhesion, and
wherein the resin powder has a number-average equivalent circle diameter of 10 micrometers or greater but 150 micrometers or less, and wherein a median in an equivalent circle diameter-based particle size distribution of the resin powder is higher than the average equivalent circle diameter.

8. A three-dimensional object producing apparatus comprising:
a layer forming unit configured to form a layer that comprises a resin powder for producing a three-dimensional object; and
a powder adhesion unit configured to make particles of the resin powder for producing a three-dimensional object in a selected region of the layer adhere to each other,
wherein the resin powder has a number-average equivalent circle diameter of 10 micrometers or greater but 150 micrometers or less, and wherein a median in an equivalent circle diameter-based particle size distribution of the resin powder is higher than the average equivalent circle diameter.

9. The three-dimensional object producing apparatus according to claim 8,
wherein the powder adhesion unit comprises a unit configured to perform electromagnetic wave irradiation.
